(19) United States
(12) Patent Application Publication
(10) Pub. No.: US 2016/0349135 A1
(43) Pub. Date: Dec. 1, 2016

(54) METAL/CERAMIC BONDED BODY, DIAPHRAGM VACUUM GAUGE, BONDING METHOD FOR METAL AND CERAMIC, AND PRODUCTION METHOD FOR DIAPHRAGM VACUUM GAUGE

(71) Applicant: ULVAC, INC., Kanagawa (JP)

(72) Inventors: Naoki TAKAHASHI, Chigasaki-shi (JP); Keisuke YOSHIDA, Chigasaki-shi (JP)

(21) Appl. No.: 15/109,612

(22) PCT Filed: Jan. 8, 2015
(86) PCT No.: PCT/JP2015/050375

§ 371 Date: Jul. 1, 2016

(30) Foreign Application Priority Data
Jan. 8, 2014 (JP) 2014-001418

(51) Int. Cl. G01L 21/00; C04B 37/02; B32B 15/04; B32B 37/14; B32B 37/06

(52) U.S. Cl. CPC G01L 21/00; B32B 37/14; B32B 37/06; B32B 15/04; C04B 37/025; B32B 2307/202; C04B 2237/10; C04B 2237/406; C04B 2237/343

(57) ABSTRACT

A metal-ceramic bonded body includes a metal member, a ceramic member, a bonding layer that is formed from a glaze and bonds the metal member and the ceramic member. A conductive layer defines an outer surface of the ceramic member and is covered by the bonding layer. The conductive layer has a higher electrical conductivity than the bonding layer. A terminal layer is located on a portion of the outer surface of the ceramic member that is separated from the metal member. The bonding layer is located between the metal member and the terminal layer. The conductive layer includes a conductive metallized layer in which metal particles are diffused in the outer surface of the ceramic member, and a conductive metal layer that covers at least a portion of the conductive metallized layer.

### RELATED APPLICATIONS

The present application is a National Phase entry of PCT Application No. PCT/JP2015/00375, filed Jan. 8, 2015, which claims priority from Japanese Patent Application No. 2014-001418, filed Jan. 8, 2014, the disclosures of which are hereby incorporated by reference herein in their entireties.

### TECHNICAL FIELD

The technology of the present disclosure is related to a metal-ceramic bonded body in which a metal member and a ceramic member are bonded, a diaphragm vacuum gauge, a method for bonding a metal and a ceramic, and a method for manufacturing a diaphragm vacuum gauge.

### BACKGROUND ART

Patent document 1 describes an example of a diaphragm vacuum gauge that includes two tubular receptacles, each having a closed end, and a diaphragm. When held between the two receptacles, the diaphragm closes an opening of each receptacle. The diaphragm and one of the receptacles form a reference pressure chamber, to which pressure that serves as a measurement reference is applied. The diaphragm and the other receptacle form a measurement pressure chamber, to which measured pressure is applied. The receptacle forming the reference pressure chamber includes an inner wall surface on which an electrode is located opposing the diaphragm. The diaphragm vacuum gauge measures electrostatic capacitance between the diaphragm and the electrode as the pressure of the measurement pressure chamber relative to the pressure of the reference pressure chamber.

### PATENT DOCUMENT

Patent Document 1: Japanese National Phase Laid-Open Patent Publication No. 2002-500351.

### SUMMARY OF THE INVENTION

In a typical diaphragm vacuum gauge, the diaphragm is bonded to the receptacles through glass-soldering or welding. When the diaphragm is bonded to the receptacles through glass-soldering or when the diaphragm is bonded to the receptacles through welding, a bonding substance that bonds the diaphragm and the receptacle changes from a liquid state to a solid state. Changes in the state of the bonding substance change the volume of the bonding substance and strain the bonding substance. Such straining is not limited to a bonding substance that bonds the diaphragm and the receptacles in the diaphragm vacuum gauge and may also occur in any bonding substance that changes from a liquid to a solid when bonding a metal member and a ceramic member.

It is an object of the technology of the present disclosure to provide a metal-ceramic bonded body, a diaphragm vacuum gauge, a method for bonding a metal and a ceramic, and a method for manufacturing a diaphragm vacuum gauge that limit straining of a bonding substance. One aspect of the technology of the present disclosure is a metal-ceramic bonded body that includes a metal member, a ceramic member, a bonding layer, a conductive layer, and a terminal layer. The bonding layer is formed from a glaze and bonds the metal member and the ceramic member. The conductive layer defines an outer surface of the ceramic member and is covered by the bonding layer. The conductive layer has a higher electrical conductivity than the bonding layer. The terminal layer is located on a portion of the outer surface of the ceramic member that is separated from the metal member. The bonding layer is located between the metal member and the terminal layer.

In this structure, before the metal member and the ceramic member are bonded by the bonding layer, voltage can be applied to between the terminal layer and the metal layer when the bonding layer is heated. This allows the solid bonding layer to bond the solid metal member and the solid ceramic member. Additionally, voltage applied to the bonding layer may be uniform at portions where the bonding layer contacts the conductive layer. More specifically, the above aspect has a structure in which when bonding the metal member and the ceramic member, the bonding layer does not fuse and can bond the metal member and the ceramic member. Consequently, the aspect limits straining of the bonding layer when bonding the metal member and the ceramic member. Further, the bonding strength between the metal member and the ceramic member may be uniform at the portions where the bonding layer contacts the conductive layer.

In a further aspect of the metal-ceramic bonded body according to the technology of the present disclosure, the terminal layer is in contact with the conductive layer. In this structure, voltage applied to the terminal layer is directly applied to the conductive layer. Thus, voltage is easily applied to a portion of the bonding layer that contacts the conductive layer. This increases the bonding strength between the metal member and the ceramic member.

One aspect of the technology of the present disclosure is a diaphragm vacuum gauge that includes a tubular ceramic receptacle having an opening, a plate-shaped metal diaphragm that closes the opening, a bonding layer that is formed from a glaze and bonds the metal diaphragm and the ceramic receptacle, a conductive layer that defines an outer surface of the ceramic receptacle and is covered by the bonding layer, and a terminal layer located on a portion of the outer surface of the ceramic receptacle that is separated from the metal diaphragm. The conductive layer has a higher electrical conductivity than the bonding layer. The bonding layer is located between the metal diaphragm and the terminal layer.

In this structure, before the metal diaphragm and the ceramic receptacle are bonded by the bonding layer, voltage can be applied to between the terminal layer and the metal diaphragm when the bonding layer is heated. This allows the solid bonding layer to bond the solid metal diaphragm and the solid bonding layer. Additionally, voltage applied to the bonding layer may be uniform at portions where the bonding layer contacts the conductive layer. More specifically, the above aspect has a structure in which the bonding layer does not fuse and can bond the metal diaphragm and the ceramic receptacle. Consequently, the aspect limits straining of the bonding layer when bonding the metal diaphragm and the ceramic receptacle. Further, the bonding strength between the metal diaphragm and the ceramic receptacle may be uniform at the portions where the bonding layer contacts the conductive layer.

In a further aspect of the diaphragm vacuum gauge according to the technology of the present disclosure, the ceramic receptacle includes an end surface that surrounds the opening. The bonding layer is located on at least a portion of the end surface of the ceramic receptacle. The conductive layer is arranged to overlap at least a portion of the bonding layer on the end surface.

In this structure, when voltage is applied to between the conductive layer and the metal diaphragm, voltage is applied to a portion of the bonding layer that overlaps the conductive layer on the end surface of the ceramic receptacle. Consequently, the metal diaphragm and the ceramic receptacle are bonded at the portions where the bonding layer overlaps the conductive layer. Thus, the position of the conductive layer can determine where the metal diaphragm and the ceramic receptacle are bonded.

In a further aspect of the diaphragm vacuum gauge according to the technology of the present disclosure, the terminal layer is in contact with the conductive layer. In this structure, voltage applied to the terminal layer is directly applied to the conductive layer. Thus, voltage is easily applied to a portion of the bonding layer that contacts the conductive layer. This increases the bonding strength between the metal diaphragm and the ceramic receptacle.

In a further aspect of the diaphragm vacuum gauge according to the technology of the present disclosure, the ceramic receptacle includes a closed end at a side opposite to the opening. The terminal layer is continuous from a circumferential surface of the ceramic receptacle to a surface of the closed end.

In this structure, when voltage is applied to between the conductive layer and the metal diaphragm, a conductive jig is used so that force can be applied from the closed end of the ceramic receptacle toward the metal diaphragm and that voltage can be applied to between the jig and the metal diaphragm. This simplifies the task needed to bond the metal diaphragm and the ceramic receptacle.

One aspect of the technology of the present disclosure is a method for bonding a metal and a ceramic. The method includes forming a terminal layer on a surface of a ceramic member; sandwiching a bonding layer, which is formed from a glaze, between a metal member and the ceramic member with the terminal layer separated from the metal member; and applying voltage to between the terminal layer and the metal member when the bonding layer is heated to a temperature that is lower than a glass-transition point of the glaze. The sandwiching a bonding layer includes covering a conductive layer, which defines an outer surface of the ceramic member and has a higher electrical conductivity than the bonding layer, with the bonding layer.

In this method, when bonding the ceramic member and the metal member, voltage is applied to between the conductive layer and the metal member with the bonding layer heated to a temperature that is lower than the glass-transition point. Thus, the solid metal member and the ceramic member are bonded by the solid bonding layer. This limits straining of the bonding layer when bonding the metal member and the ceramic member. Additionally, the bonding strength between the metal member and the ceramic member may be uniform at the portions where the bonding layer contacts the conductive layer.

One aspect of the technology of the present disclosure is a method for manufacturing a diaphragm vacuum gauge. The method includes forming a terminal layer on at least a portion of a circumferential surface of a tubular ceramic receptacle that includes an opening; sandwiching a bonding layer, which is formed from a glaze, between a plate-shaped metal diaphragm and an end surface of the ceramic receptacle that surrounds the opening with the terminal layer separated from the metal diaphragm; and applying voltage to between the terminal layer and the metal diaphragm when the bonding layer is heated to a temperature that is lower than a glass-transition point of the glaze. The sandwiching a bonding layer includes covering a conductive layer, which defines an outer surface of the ceramic receptacle and has a higher electrical conductivity than the bonding layer, with the bonding layer.

In this method, the solid metal diaphragm and the ceramic receptacle are bonded by the solid bonding layer. This limits straining of the bonding layer when bonding the metal diaphragm and the ceramic receptacle. Additionally, the bonding strength between the metal member and the ceramic member may be uniform at the portions where the bonding layer contacts the conductive layer. This increases the measurement accuracy of the diaphragm vacuum gauge compared to a manufacturing method of the diaphragm vacuum gauge in which the bonding layer is changed from a liquid to a solid.

### BRIEF DESCRIPTION OF THE DRAWINGS

FIG. 1 is a cross-sectional view showing a cross-sectional structure of one embodiment of a diaphragm vacuum gauge according to the present disclosure.

FIG. 2 is a cross-sectional view showing a cross-sectional structure of a reference receptacle.

FIG. 3 is a partially cross-sectional view showing a portion of a cross-sectional structure of the reference receptacle.

FIG. 4 is a flowchart showing the procedures of one embodiment of a method for manufacturing a diaphragm vacuum gauge.

FIG. 5 is a schematic diagram showing a voltage application step in a method for manufacturing a diaphragm vacuum gauge.

FIG. 6 is a schematic diagram showing movable ions in a bonding layer.

FIG. 7 is a schematic diagram showing a movable ion in a comparison example.

FIG. 8 is a timing chart showing timings of applying pressure, heat, and voltage when bonding a diaphragm and a receptacle.

### DESCRIPTION OF THE EMBODIMENTS

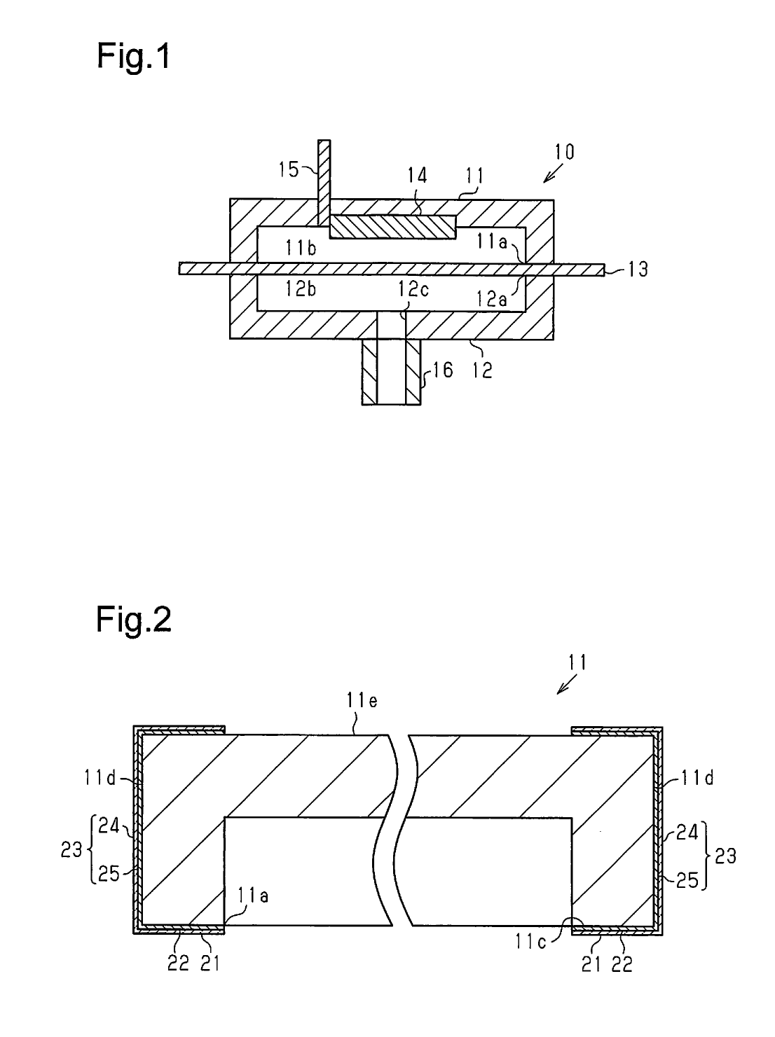

One embodiment of a metal-ceramic bonded body, a diaphragm vacuum gauge, a method for bonding a metal and a ceramic, and a method for manufacturing a diaphragm vacuum gauge according to the present disclosure will now be described with reference to FIGS. 1 to 5. The structure of a diaphragm vacuum gauge, which is one example of a metal-ceramic bonded body, and a method for manufacturing a diaphragm vacuum gauge will be sequentially described.

### [Diaphragm Vacuum Gauge Structure]

The structure of the diaphragm vacuum gauge will now be described with reference to FIGS. 1 and 2. The entire structure of the diaphragm vacuum gauge and the structure of an outer surface of the diaphragm vacuum gauge will be sequentially described.

As shown in FIG. 1, a diaphragm vacuum gauge 10 includes a reference receptacle 11, a measurement receptacle 12, and a diaphragm 13, which is one example of a metal member. The diaphragm 13 is bonded to the reference receptacle 11 and the measurement receptacle 12. The reference receptacle 11 and the measurement receptacle 12 are each one example of a ceramic member and a ceramic receptacle. The reference receptacle 11 and the measurement receptacle 12 are tubular. The receptacles 11, 12 respectively include openings 11a, 12a in one of two tube ends. The other tube ends of the receptacles 11, 12 are closed. The material forming the reference receptacle 11 and the measurement receptacle 12 is a ceramic containing, for example, aluminum oxide (Al₂O₃) as a main component. The proportion of Al₂O₃ contained in the ceramic is, for example, 85 mass percent or greater and 99 mass percent or less.

The diaphragm 13 is plate-shaped and closes the two openings 11a, 12a. The diaphragm 13 includes two opposing surfaces, and one of the surfaces is opposed to the opening 11a of the reference receptacle 11 and the other surface is opposed to the opening 12a of the measurement receptacle 12. The diameter of the diaphragm 13 is greater than the outer diameter of each of the reference receptacle 11 and the measurement receptacle 12. The diaphragm 13 extends radially outward from circumferential surfaces of the reference receptacle 11 and the measurement receptacle 12.

The material forming the diaphragm 13 is, for example, one of invar, which is an alloy containing iron and nickel, super invar, stainless invar, Kover 42 alloy (Kover is registered trademark), and the like. Alternatively, the material forming the diaphragm 13 is, for example, one of molybdenum Hastelloy (Hastelloy is registered trademark), Inconel (Inconel is registered trademark), and the like. The thermal expansion coefficients of the formation materials are substantially the same as the thermal expansion coefficient of Al₂O₃, which is the main component of the material forming the receptacles 11, 12. This limits occurrence of strain between each of the receptacles 11, 12 and the diaphragm 13 when the temperature of the receptacles 11, 12 and the diaphragm 13 changes.

The diaphragm 13 is bonded to the reference receptacle 11 and the measurement receptacle 12. When the reference receptacle 11 and the measurement receptacle 12 are bonded to the diaphragm 13, the openings 11a, 12a are opposed to each other with the diaphragm 13 located in between. The diaphragm 13 and the reference receptacle 11 form a reference pressure chamber 11b, to which pressure that serves as a measurement reference is applied. The diaphragm 13 and the measurement receptacle 12 form a measurement pressure chamber 12b, to which measured pressure is applied.

The reference receptacle 11 includes an inner wall surface on which a measurement electrode 14 is arranged opposing the diaphragm 13. The measurement electrode 14 includes a metallized layer and a metal layer. The metallized layer is formed, for example, by diffusing particles containing molybdenum and manganese or particles containing titanium on a portion of the inner wall surface. The metal layer is formed, for example, from gold, and located on the metallized layer.

A through hole extends through the closed end of the reference receptacle 11 between an outer wall surface and an inner wall surface of the closed end. An extension electrode 15 is located in the through hole. The extension electrode 15 extends outward from the outer wall surface of the closed end in an axial direction of the reference receptacle 11. The material forming the extension electrode 15 is a metal that is, for example, the same as that of the metal layer of the measurement electrode 14. The extension electrode 15 includes two ends. One of the two ends located closer to the inner wall surface is, for example, brazed to the metallized layer of the measurement electrode 14 with a brazing filler metal containing copper and silver.

A pressure application port 12c extends through the closed end of the measurement receptacle 12 between an outer wall surface and an inner wall surface of the closed end. For example, a metallized layer, in which particles containing molybdenum and manganese or particles containing titanium are diffused, is located on the outer wall surface of the closed end in at least a portion surrounding an opening of the pressure application port 12c. The metallized layer is brazed to a pressure application pipe 16 with a brazing filler metal containing, for example, copper and silver. Pressure that serves as a measurement subject of the diaphragm vacuum gauge 10 is applied to the measurement pressure chamber 12b through the pressure application pipe 16.

In the diaphragm vacuum gauge 10, when the measurement subject pressure is applied from the pressure application pipe 16 to the measurement pressure chamber 12b, the diaphragm 13 is bent in accordance with the differences in pressure between the reference pressure chamber 11b and the measurement pressure chamber 12b. For example, when the pressure of the measurement pressure chamber 12b is greater than the pressure of the reference pressure chamber 11b, the diaphragm 13 is bulged toward the closed end of the reference receptacle 11. When the pressure of the measurement pressure chamber 12b is less than the pressure of the reference pressure chamber 11b, the diaphragm 13 is bulged toward the closed end of the measurement receptacle 12. The bending of the diaphragm 13 changes electrostatic capacitance between the diaphragm 13 and the measurement electrode 14. Thus, in the diaphragm vacuum gauge 10, the electrostatic capacitance between the diaphragm 13 and the measurement electrode 14 is output as the pressure of the measurement pressure chamber 12b relative to the pressure of the reference pressure chamber 11b through the extension electrode 15.

When the reference pressure chamber 11b is under vacuum pressure, the diaphragm vacuum gauge 10 functions as an absolute pressure meter. When the reference pressure chamber 11b is released to atmospheric pressure, the diaphragm vacuum gauge 10 functions as a relative pressure meter, or a gauge pressure meter. When the diaphragm vacuum gauge 10 is an absolute pressure meter, it is preferred that the diaphragm vacuum gauge 10 include a chemical getter that adsorbs gas molecules from the reference pressure chamber 11b.

### [Outer Surface Structure of Diaphragm Vacuum Gauge]

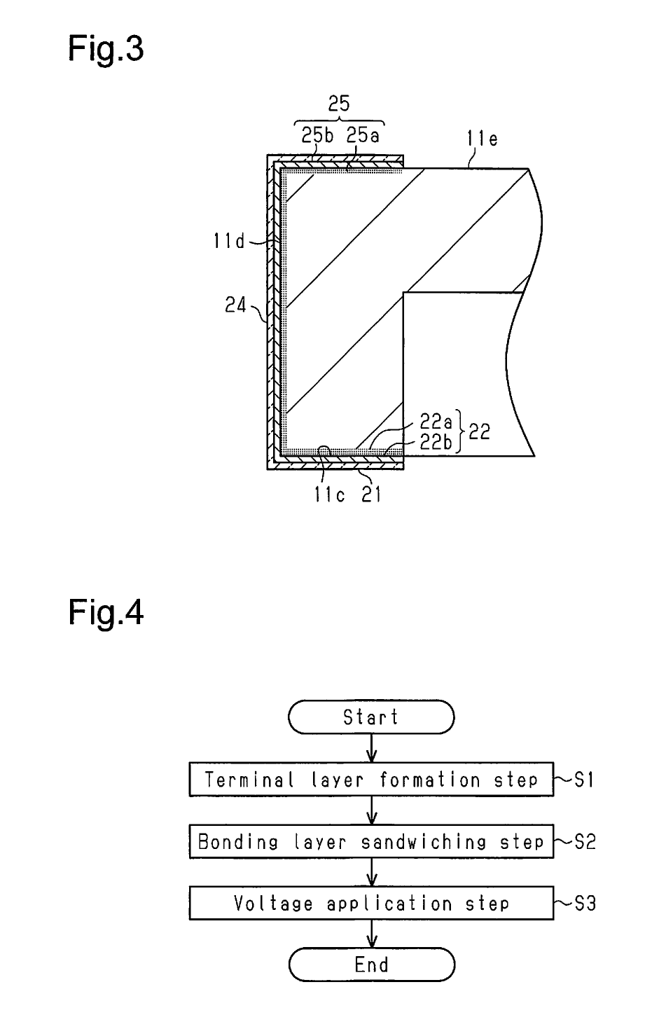

The structure of the outer surface of the diaphragm vacuum gauge 10 will now be described with reference to FIGS. 2 and 3. Although located at different positions in the diaphragm vacuum gauge 10, the outer surface of the reference receptacle 11 and the outer surface of the measurement receptacle 12 have the same structure and function. Thus, the structure of the outer surface of the reference receptacle 11 will be described in detail. The structure of the outer surface of the measurement receptacle 12 will not be described in detail. Additionally, for convenience of the description, FIG. 2 does not show the diaphragm 13, which is bonded to the reference receptacle 11, and the measurement receptacle 12, which is bonded to the diaphragm 13.

As shown in FIG. 2, the diaphragm vacuum gauge 10 includes a bonding layer 21, which is formed from a glaze and bonds the diaphragm 13 and the reference receptacle 11. The bonding layer 21 is located on the outer surface of the reference receptacle 11 at a portion surrounding the opening 11a and defining an end surface 11c. The bonding layer 21 may have the form of a dot, a band that extends in the radial direction of the end surface 11c, or a ring that extends in the radial and circumferential directions of the entire end surface 11c. Alternatively, the bonding layer 21 may have the form of a band that extends in the circumferential direction of the end surface 11c or a band that extends along the entire circumference of the end surface 11c.

For example, in the example shown in FIG. 2, the annular bonding layer 21 extends in the radial and circumferential directions of the entire end surface 11c. When located between the end surface 11c of the reference receptacle 11 and a surface of the diaphragm 13 that is opposed to the reference receptacle 11, the bonding layer 21 bonds the reference receptacle 11 and the diaphragm 13.

The glaze forming the bonding layer 21 includes a glass base and a metal element mixed into the glass base. The metal element contained in the glaze functions as a positive movable ion. The glaze contains at least one kind of metal element, for example, sodium, potassium, calcium, and the like as the metal element. The glass base forming the glaze is, for example, borosilicate glass, soda-lime glass, Kovar glass, lead glass, or the like. Here, the main component of each glass base is silicon oxide. The materials differ from one another in kind of metal oxides contained in the glass base other than silicon oxide and proportion of metal oxides relative to silicon oxide.

The diaphragm vacuum gauge 10 includes a conductive layer 22, which defines an outer surface of the reference receptacle 11 and is covered by the bonding layer 21. The conductive layer 22 may be an outer wall of the reference receptacle 11. Alternatively, the conductive layer 22 may be located on an outer wall of the reference receptacle 11 and define an outer surface of the reference receptacle 11. As another option, the conductive layer 22 may be both of the outer wall and the outer surface of the reference receptacle 11. The electrical conductivity of the conductive layer 22 is higher than the electrical conductivity of the bonding layer 21. That is, the electrical resistance of the conductive layer 22 is lower than the electrical resistance of the bonding layer 21. At least a portion of the end surface 11c in the outer surface of the reference receptacle 11 includes the conductive layer 22. The conductive layer 22 may have the form of a dot, a band that radially extends along a portion of the end surface 11c, or a ring that radially and circumferentially extends along the entire end surface 11c. Alternatively, the conductive layer 22 may have the form of a band that circumferentially extends along a portion of the end surface 11c or a band that extends along the entire circumference of the end surface 11c.

The conductive layer 22 overlaps at least a portion of the bonding layer 21 and, preferably, overlaps the entire bonding layer 21 on the end surface 11c. For example, FIG. 2 shows one example of the reference receptacle 11 in which the annular conductive layer 22 extends in the radial and circumferential directions of the entire end surface 11c and defines the outer surface of the reference receptacle 11. The conductive layer 22 overlaps the entire bonding layer 21 on the end surface 11c. The bonding layer 21 is in contact with the diaphragm 13 and the conductive layer 22, which is the outer surface of the reference receptacle 11, and bonds the diaphragm 13 and the reference receptacle 11.

The diaphragm vacuum gauge 10 includes a terminal layer 23, which is located on a portion of the outer surface of the reference receptacle 11 that is separated from the diaphragm 13. When the bonding layer 21 is located between the diaphragm 13 and the terminal layer 23, the terminal layer 23 can apply voltage applied to between the diaphragm 13 and the terminal layer 23 to the bonding layer 21. The terminal layer 23 is electrically connected to the conductive layer 22. The terminal layer 23 may be formed integrally with the conductive layer 22 from the same material. Alternatively, the terminal layer 23 and the conductive layer 22 may be formed as different layers from different materials.

In the reference receptacle 11, the terminal layer 23 is, for example, separated from the end surface 11c, which is in contact with the diaphragm 13, and located on a circumferential surface 11d of the reference receptacle 11. The terminal layer 23 may have the form of a band that circumferentially extends along a portion of the circumferential surface 11d or a band that extends along the entire circumferential surface 11d. The terminal layer 23 may have the form of a band that extends along a portion of the axis of the reference receptacle 11 or a tube that extends on the circumferential surface 11d along the entire axis. The terminal layer 23 may be located on a closed end 11e, which is located at a side of the reference receptacle 11 opposite to the opening 11a. The terminal layer 23 may have the form of a band that radially extends on a portion of the closed end 11e or a tube that extends on the entire circumferential surface 11d and the entire closed end 11e. The terminal layer 23 may have the form of a band that circumferentially extends along a portion of the closed end 11e or a ring that extends along the entire circumference of the closed end 11e. Preferably, the terminal layer 23 is continuously located on the circumferential surface 11d and the closed end 11e.

For example, FIG. 2 shows one example of the reference receptacle 11 in which the terminal layer 23 includes a high resistance terminal layer 24 and a low resistance terminal layer 25. The high resistance terminal layer 24 and the low resistance terminal layer 25 are each tubular and formed on the circumferential surface 11d along the entire axis of the reference receptacle 11 and the entire circumference. Further, each of the high resistance terminal layer 24 and the low resistance terminal layer 25 is continuously located on the circumferential surface 11d and the closed end 11e. On the closed end 11e, the high resistance terminal layer 24 and the low resistance terminal layer 25 are each annular and extends radially inward from a rim of the closed end 11e.

In the same manner as the bonding layer 21, the high resistance terminal layer 24 is formed from a glaze. The high resistance terminal layer 24 is separated from the diaphragm 13 and continuous with the bonding layer 21. The high resistance terminal layer 24 and the bonding layer 21 may be formed from a glaze having the same components or different components. The low resistance terminal layer 25 is separated from the diaphragm 13 and continuous with the conductive layer 22. The low resistance terminal layer 25 is located on the outer surface of the reference receptacle 11 and covered by the high resistance terminal layer 24. The low resistance terminal layer 25 and the conductive layer 22 may be formed from the same material or different materials.

The conductive layer 22 and the low resistance terminal layer 25 will now be described with reference to FIG. 3. For convenience of the description, FIG. 3 is a partially enlarged view showing the cross-sectional structure of the reference receptacle 11. As shown in FIG. 3, the conductive layer 22 includes a conductive metallized layer 22a and a conductive metal layer 22b. The conductive metallized layer 22a is a layer in which, for example, particles containing molybdenum and manganese or particles containing titanium are diffused on the end surface 11c of the reference receptacle 11. The electrical conductivity of the conductive metallized layer 22a is higher than the electrical conductivity of a portion of the reference receptacle 11 that is free from diffused metal particles. Also, the electrical conductivity of the conductive metallized layer 22a is higher than the electrical conductivity of the bonding layer 21.

The conductive metal layer 22b is formed from a metal, for example, gold, iron, nickel, cobalt, chromium, molybdenum, or the like through a plating process, a vacuum vapor deposition process, a sputtering process, or the like. The electrical conductivity of the conductive metal layer 22b is higher than the electrical conductivity of the bonding layer 21. The conductive metal layer 22b may cover at least a portion of the conductive metallized layer 22a or the entire conductive metallized layer 22a. When the outer surface of the reference receptacle 11 includes the conductive metal layer 22b, it is preferred that the entire conductive metal layer 22b overlap the entire conductive metallized layer 22a. This limits separation of the conductive metal layer 22b from the outer wall of the reference receptacle 11.

The conductive layer 22 does not have to include both the conductive metallized layer 22a and the conductive metal layer 22b and may only include the conductive metallized layer 22a or the conductive metal layer 22b. When the conductive layer 22 only includes the conductive metal layer 22b, it is preferred that the material forming the conductive metal layer 22b have high adhesiveness to the ceramic that forms the reference receptacle 11.

FIG. 3 shows one example of the reference receptacle 11 in which the conductive metallized layer 22a is radially and circumferentially located along the entire end surface 11c, and the conductive metal layer 22b covers the entire conductive metallized layer 22a.

In the same manner as the conductive layer 22, the low resistance terminal layer 25 includes a terminal metallized layer 25a and a terminal metal layer 25b. The terminal metallized layer 25a is a layer in which, for example, particles containing molybdenum and manganese or particles containing titanium are diffused on the circumferential surface 11d of the reference receptacle 11 and a portion of the closed end 11e. The electrical conductivity of the terminal metallized layer 25a is higher than the electrical conductivity of the high resistance terminal layer 24. The terminal metallized layer 25a is separated from the diaphragm 13 and continuous with the conductive metallized layer 22a. The terminal metallized layer 25a and the conductive metallized layer 22a may be formed from the same material or different materials.

The terminal metal layer 25b is formed from a metal, for example, gold, iron, nickel, cobalt, chromium, molybdenum, or the like through a plating process, a vacuum vapor deposition process, a sputtering process, or the like. The electrical conductivity of the terminal metal layer 25b is higher than the electrical conductivity of the bonding layer 21. The terminal metal layer 25b may cover a portion of the terminal metallized layer 25a or the entire conductive metallized layer 22a. When the terminal metal layer 25b is located on the outer wall of the reference receptacle 11, it is preferred that the entire terminal metal layer 25b overlaps the entire terminal metallized layer 25a. This limits separation of the terminal metal layer 25b from the outer wall of the reference receptacle 11. The terminal metal layer 25b and the conductive metal layer 22b may be formed form the same material or different materials.

The low resistance terminal layer 25 does not have to include both the terminal metallized layer 25a and the terminal metal layer 25b and may only include the terminal metallized layer 25a or the terminal metal layer 25b. When the low resistance terminal layer 25 only includes the terminal metal layer 25b, it is preferred that the material forming the terminal metal layer 25b have high adhesiveness to the ceramic that forms the reference receptacle 11.

FIG. 3 shows one example of the reference receptacle 11 in which the terminal metallized layer 25a is tubular and formed on the circumferential surface 11d along the entire axis of the reference receptacle 11 and the entire circumference. Further, the terminal metallized layer 25a is continuously located on the circumferential surface 11d and the closed end 11e. On the closed end 11e, the terminal metallized layer 25a is annular and extends radially inward from the rim of the closed end 11e. The terminal metal layer 25b covers the entire terminal metallized layer 25a. The terminal metal layer 25b is separated from the diaphragm 13 and continuous with the conductive metal layer 22b.

### [Diaphragm Vacuum Gauge Manufacturing Method]

The method for manufacturing the diaphragm vacuum gauge 10 will now be described with reference to FIGS. 4 to 8. The procedures in the method for manufacturing the diaphragm vacuum gauge 10 will be described. Then, the voltage application step will be described.

The procedures in the manufacturing method of the diaphragm vacuum gauge 10 will now be described with reference to FIG. 4. As shown in FIG. 4, the method for manufacturing the diaphragm vacuum gauge 10 includes a terminal layer formation step (step S1), a bonding layer sandwiching step (step S2), and a voltage application step (step S3). In the terminal layer formation step, the terminal layer 23 is formed on at least one of the reference receptacle 11 and the measurement receptacle 12 and, preferably, both the reference receptacle 11 and the measurement receptacle 12.

In the terminal layer formation step, when the terminal layer 23 is formed from only the high resistance terminal layer 24, a glaze is applied to the outer surface of at least one of the reference receptacle 11 and the measurement receptacle 12. The applied glaze is sintered to form the terminal layer 23. When the high resistance terminal layer 24 is formed in the terminal layer formation step, the bonding layer 21 and the high resistance terminal layer 24 may be formed at the same time. Alternatively, the bonding layer 21 may be formed prior or subsequent to the terminal layer formation step. When the high resistance terminal layer 24 is not formed in the terminal layer formation step, the bonding layer 21 only needs to be formed prior to the bonding layer sandwiching step.

In the terminal layer formation step, when the terminal layer 23 is formed from only the low resistance terminal layer 25, and the low resistance terminal layer 25 is formed from the terminal metallized layer 25a and the terminal metal layer 25b, the terminal metallized layer 25a is formed on the outer surface of at least one of the reference receptacle 11 and the measurement receptacle 12. Then, the terminal metal layer 25b is formed on the outer surface where the terminal metallized layer 25a is formed.

When the low resistance terminal layer 25 is formed from only the terminal metallized layer 25a, only the terminal metallized layer 25a is formed on the outer surface of at least one of the reference receptacle 11 and the measurement receptacle 12. When the low resistance terminal layer 25 is formed from only the terminal metal layer 25b, only the terminal metal layer 25b is formed on the outer surface of at least one of the reference receptacle 11 and the measurement receptacle 12. In the terminal layer formation step, when the low resistance terminal layer 25 is formed, the conductive layer 22 and the low resistance terminal layer 25 may be formed at the same time. Alternatively, the conductive layer 22 may be formed prior or subsequent to the terminal layer formation step. In the terminal layer formation step, when the low resistance terminal layer 25 is not formed, the conductive layer 22 only needs to be formed prior to the bonding layer sandwiching step.

In the terminal layer formation step, when the terminal layer 23 is formed from the high resistance terminal layer 24 and the low resistance terminal layer 25, a process for forming the low resistance terminal layer 25 is performed. Then, a process for forming the high resistance terminal layer 24 is performed.

In the bonding layer sandwiching step, with the terminal layer 23 separated from the diaphragm 13, the bonding layer 21 is sandwiched between the diaphragm 13 and at least one of the reference receptacle 11 and the measurement receptacle 12. In the bonding layer sandwiching step, the bonding layer 21 formed on at least one of the reference receptacle 11 and the measurement receptacle 12 may be sandwiched between the diaphragm 13 and one of the receptacles 11, 12 on which the bonding layer 21 is formed. Alternatively, in the bonding layer sandwiching step, the bonding layer 21 formed on at least one of two opposite surfaces of the diaphragm 13 may be sandwiched between the diaphragm 13 and the receptacle that is opposed to the bonding layer 21.

In the bonding layer sandwiching step, the outer surface of at least one of the reference receptacle 11 and the measurement receptacle 12 includes the conductive layer 22, which has a higher electrical conductivity than the bonding layer 21, and the conductive layer 22 is covered by the bonding layer 21. When the reference receptacle 11 and the measurement receptacle 12 include the bonding layer 21, the conductive layer 22 may define only the outer surface of the reference receptacle 11 or the outer surface of the measurement receptacle 12. Alternatively, the conductive layer 22 may define the outer surfaces of the reference receptacle 11 and the measurement receptacle 12. In the bonding layer sandwiching step, when the conductive layer 22 is formed from the conductive metallized layer 22a, the conductive metallized layer 22a defines the outer surface of at least one of the reference receptacle 11 and the measurement receptacle 12. When the conductive metallized layer 22a defines the outer surface of at least one of the two receptacles, the bonding layer 21 may be included in the receptacle that includes the conductive metallized layer 22a or formed on a portion of the diaphragm 13 that covers the conductive metallized layer 22a.

In the bonding layer sandwiching step, when the conductive layer 22 is formed from the conductive metal layer 22b, the conductive metal layer 22b defines the outer surface of at least one of the reference receptacle 11 and the measurement receptacle 12. When the conductive metal layer 22b defines the outer surface of at least one of the two receptacles, it is preferred that the bonding layer 21 be formed on a portion of the diaphragm 13 that covers the conductive metal layer 22b.

In the bonding layer sandwiching step, when the conductive layer 22 is formed from the conductive metallized layer 22a and the conductive metal layer 22b, the conductive metallized layer 22a and the conductive metal layer 22b define the outer surface of at least one of the reference receptacle 11 and the measurement receptacle 12.

In the bonding layer sandwiching step, in any case that is described above, the bonding layer 21 is applied to at least one of the two receptacles or the diaphragm 13 and sintered into a solid state prior to the bonding layer sandwiching step.

In the voltage application step, when the bonding layer 21 is heated to a temperature that is lower than the glass-transition point of the glaze, voltage is applied to between the terminal layer 23 and the diaphragm 13. In the voltage application step, when the terminal layer 23 includes the low resistance terminal layer 25, voltage is easily applied to between the terminal layer 23 and the diaphragm 13 compared to when the terminal layer 23 only includes the high resistance terminal layer 24. In the voltage application step, when the terminal layer 23 includes the high resistance terminal layer 24 and the low resistance terminal layer 25, voltage is applied to between the terminal layer 23 and the diaphragm 13 mainly through the low resistance terminal layer 25. Also, the voltage is applied through the high resistance terminal layer 24.

In the voltage application step, when voltage is applied to between the terminal layer 23 and the diaphragm 13, the bonding layer 21 is heated. This increases the electrical conductivity of the bonding layer 21. Thus, the metal elements contained in the bonding layer 21 function as positive movable ions. In the voltage application step, such charge movement between the bonding layer 21 and the diaphragm 13 bonds at least one of the reference receptacle 11 and the measurement receptacle 12 and the diaphragm 13 with the bonding layer 21.

In the voltage application step, DC voltage may be applied to between the terminal layer 23 and the diaphragm 13. When DC voltage is applied to between the terminal layer 23 and the diaphragm 13, the terminal layer 23 may have a positive electrical potential when the diaphragm 13 has a negative electrical potential or the terminal layer 23 may have a negative electrical potential when the diaphragm 13 has a positive electrical potential. Alternatively, in the voltage application step, the positive and negative potentials may be switched between the terminal layer 23 and the diaphragm 13 during DC voltage application. In this case, the voltage application only needs to move the movable ions from the bonding layer 21 to the surface of a bonded subject and advance the reaction necessary for bonding in the surface of the bonded subject.

In the voltage application step, when the terminal layer 23 has a positive potential and the diaphragm 13 has a negative potential, it is preferred that the end surfaces of the receptacles 11, 12 each have the bonding layer 21. In the voltage application step, when the terminal layer 23 has a negative potential and the diaphragm 13 has a positive potential, it is preferred that the end surfaces of the receptacles 11, 12 be formed from the conductive layer 22 and that the diaphragm 13 include the bonding layer 21.

In the voltage application step, AC voltage may be applied to between the terminal layer 23 and the diaphragm 13. When AC voltage is applied to between the terminal layer 23 and the diaphragm 13, the movable ions only need to move from the bonding layer 21 to the surface of a bonded subject, and the reaction necessary for bonding proceeds in the surface of the bonded subject.

In the voltage application step, when voltage is applied to between the terminal layer 23 and the diaphragm 13, the movable ions may be concentrated in the bonding layer 21. The movable ions move in the bonding layer 21 from a portion having a relatively positive potential toward a portion having a relatively negative potential. Thus, when DC voltage is applied to between the terminal layer 23 and the diaphragm 13, the terminal layer 23 has a positive potential, and the diaphragm 13 has a negative potential, the movable ions are concentrated at a portion of the bonding layer 21 that is in contact with the diaphragm 13.

When DC voltage is applied to between the terminal layer 23 and the diaphragm 13, the terminal layer 23 has a negative potential, and the diaphragm 13 has a positive potential, the movable ions are concentrated at a portion of the bonding layer 21 that is in contact with the conductive layer 22.

In the voltage application step, when voltage is applied to between the terminal layer 23 and the diaphragm 13, the movable ions do not have to be concentrated in the bonding layer 21. However, to prevent the unevenness of the movable ions in the bonding layer 21, the polarity of voltage applied to between the terminal layer 23 and the diaphragm 13 needs to be switched during the bonding of the diaphragm 13 to at least one of the two receptacles 11, 12. This complicates the process for applying voltage to the terminal layer 23 and the diaphragm 13.

In the voltage application step, only the bonding layer 21 needs to be heated to a temperature that is lower than the glass-transition point of the glaze forming the bonding layer 21. Thus, when the terminal layer 23 includes the high resistance terminal layer 24 formed from the glaze, the high resistance terminal layer 24 may be heated to a temperature that is lower than the glass-transition point of the glaze or the glass-transition point or above. Even when the high resistance terminal layer 24 is heated to the glass-transition point of the glaze or above, straining of the bonding layer 21 may be limited when at least one of the two receptacles 11, 12 are bonded to the diaphragm 13 as long as the bonding layer 21 is below the glass-transition point, that is, solid.

When the diaphragm vacuum gauge 10 shown in FIG. 1 is manufactured as one example of a diaphragm vacuum gauge, the process described below is performed prior to the terminal layer formation step. In the method for manufacturing the diaphragm vacuum gauge 10, for example, the tubular reference receptacle 11 and the tubular measurement receptacle 12, each having a closed end, are prepared. The material forming the reference receptacle 11 and the measurement receptacle 12 is a ceramic as described above. The reference receptacle 11 includes the through hole for the extension electrode 15. The measurement receptacle 12 includes the pressure application port 12c.

When the reference receptacle 11 and the measurement receptacle 12 are prepared, the plate-shaped diaphragm 13 is also prepared to close the openings 11a, 12a of the receptacles 11, 12. The material forming the diaphragm 13 is a metal as described above. The diaphragm 13 has the form of a plate that is greater than the outer diameter of each of the receptacles 11, 12.

When the receptacles 11, 12 and the diaphragm 13 are prepared, the measurement electrode 14 is formed on an inner wall surface of the reference receptacle 11 at a position opposed to the diaphragm 13. When forming the measurement electrode 14, for example, a metal paste containing molybdenum and manganese or a metal paste containing titanium is applied to a portion of the inner wall surface of the reference receptacle 11 and sintered. This thermally diffuses particles containing molybdenum and manganese or particles containing titanium and forms a metallized layer on the portion of the inner wall surface. Then, a gold metal layer is formed on the metallized layer, for example, through a plating process, a vacuum vapor deposition process, or a sputtering process. The extension electrode 15 is inserted into the through hole of the reference receptacle 11.

In the same manner as when forming the measurement electrode 14, a metallized layer is formed on the outer wall surface of the measurement receptacle 12 at a portion surrounding the pressure application port 12c. The pressure application pipe 16 is brazed to the metallized layer when the opening of the pressure application pipe 16 is opposed to the pressure application port 12c.

### [Voltage Application Step]

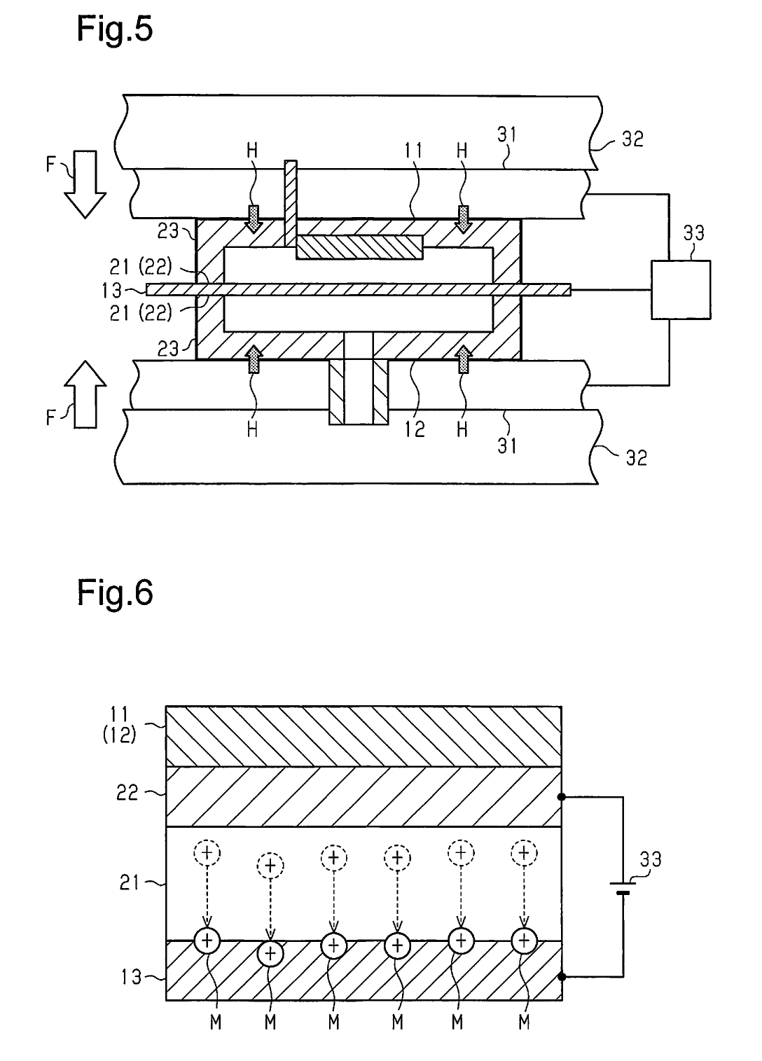

The voltage application step will now be described in detail with reference to FIGS. 5 to 8. One example of the voltage application step will be described in which the bonding layer 21 bonds the reference receptacle 11 and the measurement receptacle 12 to the diaphragm 13.

As shown in FIG. 5, in the example of the voltage application step, the reference receptacle 11 and the measurement receptacle 12, which are located having the diaphragm 13 in between, each contact a heater 31. The receptacles 11, 12 receive heat H from the heaters 31. The bonding layers 21, which are located between the diaphragm 13 and each of the receptacles 11, 12, receive heat H from the heaters 31 and are heated to a temperature that is lower than the glass-transition point of the glaze forming the bonding layers 21.

The reference receptacle 11 and the measurement receptacle 12 are held between jigs 32 from an outer side of each heater 31. Each jig 32 is formed from a conductive material, for example gold. When contacting the heaters 31, the jigs 32 apply pressure F directed from the closed ends of the receptacles 11, 12 toward the diaphragm 13 to the receptacles 11, 12. The bonding layers 21, which are sandwiched between each of the receptacles 11, 12 and the diaphragm 13, receive the pressure F from the jigs 32 and come in close contact with the diaphragm 13. The jigs 32 apply the pressure F to the receptacles 11, 12 so that, for example, a gap is not formed between the surface of each bonding layer 21 and a surface of the diaphragm 13.

The diaphragm 13 and the two jigs 32 are connected to a DC power supply 33, which applies DC voltage to between the diaphragm 13 and each jig 32. The DC power supply 33 includes positive terminals, which are connected to the jigs 32, and a negative terminal, which is connected to the DC power supply 33. Thus, DC voltage is applied to between the diaphragm 13 and the terminal layer 23 of each of the receptacles 11, 12. In this case, the diaphragm 13 has a negative potential, and the bonding layers 21 have a positive potential.

In the example of the voltage application step shown in FIG. 5, the terminal layer 23 is continuous with the circumferential surface and the closed end of each of the receptacles 11, 12. Thus, when voltage is applied to between each conductive layer 22 and the diaphragm 13, the jigs 32 is used so that force directed from the closed ends of the receptacles 11, 12 toward the diaphragm 13 can be applied and that voltage can be applied to between each jig 32 and the diaphragm 13. This simplifies the task needed to bond the diaphragm 13 and the receptacles 11, 12.

As shown in FIG. 6, when applying voltage to between the diaphragm 13 and each terminal layer 23, voltage is applied to between the diaphragm 13 and each conductive layer 22. Thus, the conductive layer 22 has a positive potential, and the diaphragm 13 has a negative potential. In this case, the heat H and the pressure F are applied to the bonding layers 21. This increases the electrical conductivity of the bonding layers 21. Thus, when voltage is applied to between each conductive layer 22 and the diaphragm 13, metal elements contained in the bonding layers 21 function as positive movable ions M. Consequently, charges may be moved between each bonding layer 21 and the diaphragm 13.

Further, the conductive layer 22, which is in contact with the bonding layer 21, is located on the end surface of each of the receptacles 11, 12. Thus, voltage applied to the bonding layer 21 may be uniform at portions where the bonding layer 21 contacts the conductive layer 22.

The movable ions M, which function as positive charge carriers, move toward the diaphragm 13, which has a negative potential. Thus, the movable ions M are concentrated at a portion of the bonding layer 21 that is in contact with the diaphragm 13. Some of the movable ions M move from the bonding layer 21 to the diaphragm 13.

In the portion of the bonding layer 21 that is in contact with the diaphragm 13, the movable ions M reduce silicon oxide, which forms the bonding layer 21, and metal oxide formed on the surface of the diaphragm 13. When oxygen is removed, silicon oxide and metal oxide change from a stable state, as an oxide, to an unstable state, as a single element. Such unstable silicon and metal are bonded to each other to become stable. This bonds boundary surfaces of the solid bonding layer 21 and the diaphragm 13.

Voltage applied to the bonding layer 21 may be uniform at the portions where the bonding layer 21 contacts the conductive layer 22. Thus, the movable ions M may move toward the diaphragm 13 by a uniform amount. Accordingly, the portions where the bonding layer 21 contacts the conductive layer 22 may have uniform bonding strength between the diaphragm 13 and each of the receptacles 11, 12.

Additionally, voltage is easily applied to a portion of the bonding layer 21 that is in contact with the conductive layer 22 compared to other portions of the bonding layer 21. Thus, the conductive layer 22 may determine a portion of the bonding layer 21 that bonds each receptacle 11, 12 and the diaphragm 13.

In this case, before the diaphragm 13 and the reference receptacle 11 are bonded by the bonding layer 21, voltage is applied to between the terminal layer 23 and the diaphragm 13 when the bonding layer 21 is heated. This allows the solid bonding layer 21 to bond the solid diaphragm 13 and the solid receptacles 11, 12. Additionally, voltage applied to the bonding layer 21 may be uniform at the portions where the bonding layer 21 contacts the conductive layer 22. More specifically, when bonding the diaphragm 13 to the receptacles 11, 12, the bonding layers 21 do not fuse and can bond the diaphragm 13 and the receptacles 11, 12. This limits straining of the bonding layers 21 when bonding the diaphragm 13 and the receptacles 11, 12. Further, the bonding strength between the diaphragm 13 and each of the receptacles 11, 12 may be uniform at the portions where the bonding layer 21 contacts the conductive layer 22.

In the manufactured diaphragm vacuum gauge 10, the movable ions M are concentrated at the portion of the bonding layer 21 that is in contact with the diaphragm 13. This facilitates the bonding through voltage application between the terminal layer 23 and the diaphragm 13 compared to when the movable ions M are uniformly located.

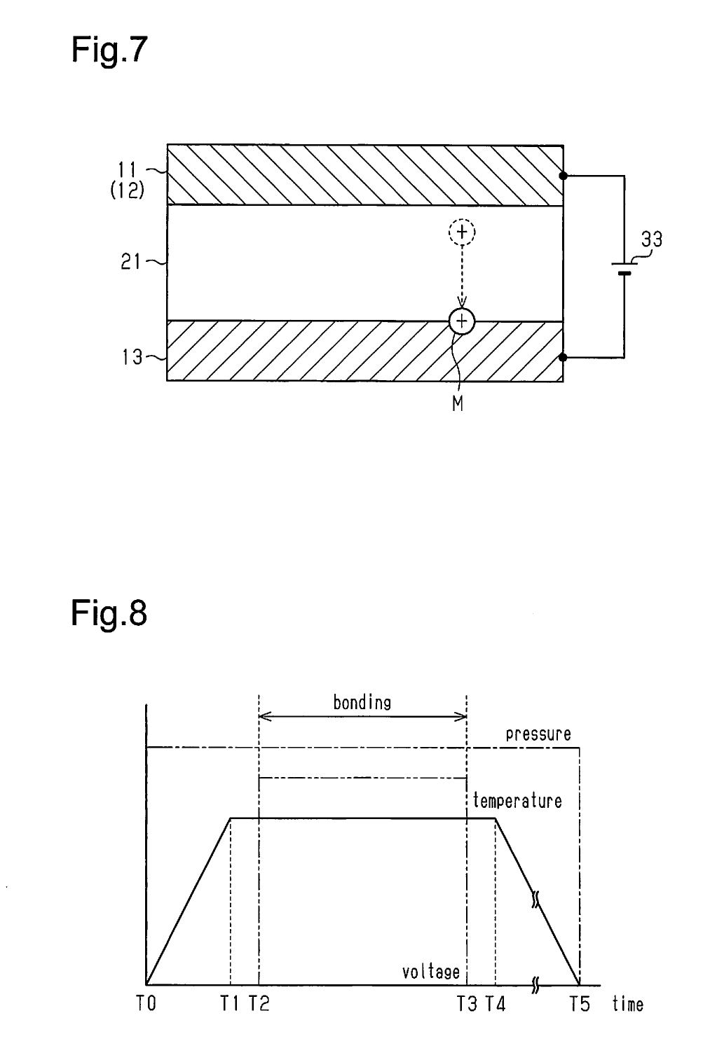

As shown in FIG. 7, in a structure that does not include the conductive layer 22, voltage is applied to the bonding layer 21 when voltage is applied to between the terminal layer 23 and the diaphragm 13. In this case, the pressure and heat applied to the bonding layer 21 increases the electrical conductivity of the bonding layer 21 compared to when the bonding layer 21 is at a normal temperature. However, the electrical conductivity of the bonding layer 21 is lower than the electrical conductivity of the conductive layer 22. This limits portions of the bonding layer 21 in which metal ions contained in the bonding layer 21 function as the movable ions M. For example, only a portion of the bonding layer 21 that is located most proximate to the jig 32, which applies voltage to the bonding layer 21, receives enough voltage to allow the metal ions to function as the movable ions M. Consequently, the diaphragm 13 and each of the receptacles 11, 12 are bonded by only a portion of the bonding layer 21.

When the diaphragm vacuum gauge 10 is an absolute pressure meter, the receptacles 11, 12 and the diaphragm 13 are bonded in a reduced pressure environment, for example, a vacuum environment of 10⁻³ Pa or below. When the diaphragm vacuum gauge 10 is a gauge pressure meter, the receptacles 11, 12 and the diaphragm 13 are bonded in an atmospheric pressure environment.

The step of bonding the diaphragm 13 and the receptacles 11, 12 in a vacuum environment will be described as one example of the voltage application step with reference to FIG. 8. In FIG. 8, the sold lines indicate changes in the temperature of the bonding layer 21, the single-dashed lines indicate changes in the pressure applied to between the reference receptacle 11 and the measurement receptacle 12, and the double-dashed lines indicate changes in the voltage applied to between the bonding layer 21 and the diaphragm 13.

When bonding the receptacles 11, 12 to the diaphragm 13, the reference receptacle 11 and the measurement receptacle 12 are aligned with the diaphragm 13 in an atmospheric pressure environment. When the reference receptacle 11, the measurement receptacle 12, and the diaphragm 13 are held together with the heaters 31, which heat the receptacles 11, 12, between the jigs 32, the reference receptacle 11 and the measurement receptacle 12 are pressed against the diaphragm 13 at predetermined pressure F.

The reference receptacle 11, the measurement receptacle 12, and the diaphragm 13 are located in a vacuum environment when the predetermined pressure F is applied to between the reference receptacle 11 and the measurement receptacle 12. When the receptacles 11, 12 and the diaphragm 13 are located in the vacuum environment, the gas is discharged from the receptacles 11, 12 through gaps between the bonding layer 21 and the diaphragm 13. In this process, when pressure is applied to the receptacles 11, 12 in an atmospheric pressure environment, the receptacles 11, 12 and the diaphragm 13 are located in a vacuum environment. This eliminates the need to prepare an actuator that can be operated in a vacuum environment and simplifies the structure of a device used in the voltage application step.

As shown in FIG. 8, when the reference receptacle 11, the measurement receptacle 12, and the diaphragm 13 are located in a vacuum environment, at timing T0, the reference receptacle 11 and the measurement receptacle 12 start to be heated and the temperature of the bonding layers 21 starts to increase. At timing T1, when the temperature of the bonding layers 21 reaches a predetermined temperature that is below the glass-transition point of the bonding layers 21, for example, a predetermined temperature included in a range from 300° C. to 800° C., the temperature of the bonding layers 21 is maintained constant until the receptacles 11, 12 and the diaphragm 13 are bonded.

When the temperature of the bonding layers 21 reaches the predetermined temperature, at timing T2, voltage starts to be applied to between each terminal layer 23 and the diaphragm 13. A predetermined voltage, for example, a predetermined voltage included in a range from 300 V to 1000 V, is applied to between the terminal layer 23 and the diaphragm 13. Even when the applied voltage is lower than 300 V or higher than 1000 V, the diaphragm 13 and the receptacles 11, 12 can be bonded. However, when the applied voltage is lower than 300 V, movement of the movable ions M is hindered. When the applied voltage is higher than 1000 V, the movable ions M move faster than when the applied voltage is 1000 V or lower. This tends to decrease the bonding strength between the diaphragm 13 and the receptacles 11, 12. Thus, the pressure application between each of the receptacles 11, 12 and the diaphragm 13, the heating of the bonding layer 21, and the voltage application to the conductive layers 22 are simultaneously performed at timing T2. This starts the above bonding reaction at the portions where the bonding layers 21 contact the diaphragm 13 from timing T2.

The simultaneous performance of the pressure application, the heating, and the voltage application is maintained for a predetermined period, at timing T3, the voltage application is terminated. The receptacles 11, 12 and the diaphragm 13 are bonded by the bonding layers 21, which are located between each of the receptacles 11, 12 and the diaphragm 13, from timing T2 to timing T3.

Timing T3, at which the voltage application is terminated, only needs to be set in advance to a timing, for example, when a predetermined time elapses from timing T2. When the voltage application is terminated, at timing T4, the heating of the receptacles 11, 12 is terminated and the temperature of the bonding layers 21 starts to decrease. When the temperature of the bonding layers 21 is decreased to a predetermined temperature, at timing T5, the receptacles 11, 12 and the diaphragm 13, which have been bonded, are removed from the vacuum environment to the atmospheric pressure environment. The jigs 32, which apply pressure between each of the receptacles 11, 12 and the diaphragm 13, are removed from the receptacles 11, 12.

Accordingly, the embodiment has the advantages described below.

(1) In the structure of the metal-ceramic bonded body (diaphragm vacuum gauge 10) of the embodiment, before the diaphragm 13 and the receptacles 11, 12 are bonded by the bonding layers 21, voltage can be applied to between each terminal layer 23 and the diaphragm 13 when the bonding layers 21 are heated. This allows the solid bonding layers 21 to bond the solid diaphragm 13 and the solid receptacles 11, 12. Additionally, voltage applied to the bonding layers 21 may be uniform at the portions where the bonding layers 21 contact the conductive layers 22. More specifically, the metal-ceramic bonded body (diaphragm vacuum gauge 10) of the embodiment has the structure in which when bonding the diaphragm 13 and the receptacles 11, 12, the bonding layers 21 do not fuse and can bond the diaphragm 13 and the receptacles 11, 12. This limits straining of the bonding layers 21 when bonding the diaphragm 13 and the receptacles 11, 12. Further, the bonding strength between the diaphragm 13 and each of the receptacles 11, 12 may be uniform at the portions where the bonding layers 21 contact the conductive layers 22.

(2) The conductive layer 22, which is connected to the terminal layer 23, defines the outer surface of each of the receptacles 11, 12. Thus, voltage applied to the terminal layer 23 is directly applied to the conductive layer 22. This easily applies voltage to a portion of the bonding layer 21 that is in contact with the conductive layer 22 and increases the bonding strength between the diaphragm 13 and each of the receptacles 11, 12.

(3) When voltage is applied to between each conductive layer 22 and the diaphragm 13, voltage is applied to the portions of the bonding layers 21 that overlap the conductive layers 22 at the end surfaces of the receptacles 11, 12. The diaphragm 13 and the receptacles 11, 12 are bonded by the portions of the bonding layers 21 that overlap the conductive layers 22. Thus, the position of the conductive layers 22 determines where the diaphragm 13 and the receptacles 11, 12 are bonded.

(4) When applying voltage to between each conductive layer 22 and the diaphragm 13, the conductive jigs 32 are used so that pressure can be applied from the closed ends 11e of the receptacles 11, 12 toward the diaphragm 13 and that voltage can be applied to between each jig 32 and the diaphragm 13. This simplifies the task needed to bond the diaphragm 13 and the receptacles 11, 12.

The embodiment may be modified as follows.

The application of the heat H to the bonding layer 21, the pressing of the receptacles 11, 12 toward the diaphragm 13, and the voltage application between each terminal layer 23 and the diaphragm 13 do not have to be started and terminated at the timings shown in FIG. 8. The process of applying heat H, pressure F, and voltage may each be changed. As long as heat, pressure, and voltage are simultaneously applied, the receptacles 11, 12 and the diaphragm 13 can be bonded.

The diaphragm 13 only needs to be large enough to close the openings 11a, 12a of the receptacles 11, 12. The diameter of the diaphragm 13 may be the same as the outer diameter of each of the receptacles 11, 12. Alternatively, the diameter of the diaphragm 13 may be smaller than the outer diameter of each of the receptacles 11, 12. Even in such a structure, voltage can be applied to between the diaphragm 13 and each of the terminal layers 23, which are formed on the receptacles 11, 12.

The metal element included in the glaze is not limited to sodium, potassium, or calcium and may be another metal element. The metal element only needs to function as movable ions in the bonding layers 21 when voltage is applied to between each terminal layer 23 and the diaphragm 13.

The glass base included in the glaze may be glass other than borosilicate glass, soda-lime glass, Kovar glass, and lead glass and may be, for example, fused quartz.

The material forming the reference receptacle 11 and the measurement receptacle 12 may be a ceramic other than Al₂O₃, and may be for example, a ceramic the main component of which is zirconium oxide, silicon nitride, silicon carbide, aluminum nitride, or the like. Even when such a ceramic is the material forming the receptacles 11, 12, the receptacles 11, 12 and the diaphragm 13 can be bonded by the solid bonding layers 21.

The material forming the diaphragm 13 is not limited to the above alloy and may be a metal, for example, iron, nickel, cobalt, chromium, or molybdenum. When such a metal is the material forming the diaphragm 13, the receptacles 11, 12 and the diaphragm 13 can be bonded by the solid bonding layers 21.

The material forming the measurement electrode 14 and the extension electrode 15 may be a metal other than that describe above and may be, for example, copper or tungsten.

The diaphragm vacuum gauge 10 is one example of the metal-ceramic bonded body. The metal-ceramic bonded body according to the technology of the present disclosure is not limited to the diaphragm vacuum gauge 10 and only needs to be a metal-ceramic bonded body in which a metal member and a ceramic member is bonded by a bonding layer formed from a glaze and the bonding layer is continuous with a terminal layer.

1. A metal-ceramic bonded body comprising:
a metal member;
a ceramic member;
a bonding layer that is formed from a glaze and bonds the metal member and the ceramic member;
a conductive layer that defines an outer surface of the ceramic member and is covered by the bonding layer, wherein the conductive layer has a higher electrical conductivity than the bonding layer; and
a terminal layer located on a portion of the outer surface of the ceramic member that is separated from the metal member, wherein the bonding layer is located between the metal member and the terminal layer,
wherein the conductive layer includes
a conductive metallized layer in which metal particles are diffused in the outer surface of the ceramic member, and
a conductive metal layer that covers at least a portion of the conductive metallized layer.

2. The metal-ceramic bonded body according to claim 1, wherein the terminal layer is in contact with the conductive layer.

3. A diaphragm vacuum gauge comprising:
a tubular ceramic receptacle having an opening;
a plate-shaped metal diaphragm that closes the opening;
a bonding layer that is formed from a glaze and bonds the metal diaphragm and the ceramic receptacle;
a conductive layer that defines an outer surface of the ceramic receptacle and is covered by the bonding layer, wherein the conductive layer has a higher electrical conductivity than the bonding layer; and
a terminal layer located on a portion of the outer surface of the ceramic receptacle that is separated from the metal diaphragm, wherein the bonding layer is located between the metal diaphragm and the terminal layer,
wherein the conductive layer includes
a conductive metallized layer in which metal particles are diffused in the outer surface of the ceramic receptacle, and
a conductive metal layer that covers at least a portion of the conductive metallized layer.

4. The diaphragm vacuum gauge according to claim 3, wherein
the ceramic receptacle includes an end surface that surrounds the opening;
the bonding layer is located on at least a portion of the end surface; and
the conductive layer is arranged to overlap at least a portion of the bonding layer on the end surface.

5. The diaphragm vacuum gauge according to claim 3, wherein the terminal layer is in contact with the conductive layer.

6. The diaphragm vacuum gauge according to claim 5, wherein
the ceramic receptacle includes a closed end at a side opposite to the opening; and
the terminal layer is continuous from a circumferential surface of the ceramic receptacle to a surface of the closed end.

7. A method for bonding a metal and a ceramic, the method comprising:
forming a terminal layer on a surface of a ceramic member;
sandwiching a bonding layer, which is formed from a glaze, between a metal member and the ceramic member with the terminal layer separated from the metal member; and
applying voltage to between the terminal layer and the metal member when the bonding layer is heated to a temperature that is lower than a glass-transition point of the glaze,
wherein the sandwiching a bonding layer includes covering a conductive layer, which defines an outer surface of the ceramic member and has a higher electrical conductivity than the bonding layer, with the bonding layer, and
the conductive layer includes
a conductive metallized layer in which metal particles are diffused in the outer surface of the ceramic member, and
a conductive metal layer that covers at least a portion of the conductive metallized layer.

8. A method for manufacturing a diaphragm vacuum gauge, the method comprising:
forming a terminal layer on at least a portion of a circumferential surface of a tubular ceramic receptacle that includes an opening;
sandwiching a bonding layer, which is formed from a glaze, between a plate-shaped metal diaphragm and an end surface of the ceramic receptacle that surrounds the opening with the terminal layer separated from the metal diaphragm; and
applying voltage to between the terminal layer and the metal diaphragm when the bonding layer is heated to a temperature that is lower than a glass-transition point of the glaze,
wherein the sandwiching a bonding layer includes covering a conductive layer, which defines an outer surface of the ceramic receptacle and has a higher electrical conductivity than the bonding layer, with the bonding layer, and
the conductive layer includes
a conductive metallized layer in which metal particles are diffused in the outer surface of the ceramic receptacle, and
a conductive metal layer that covers at least a portion of the conductive metallized layer.
